(19) United States
(12) Patent Application Publication
(10) Pub. No.: US 2004/0207586 A1
(43) Pub. Date: Oct. 21, 2004

(54) Image processing device for digital display

(76) Inventors: Jui-Yuan Tsai, Tainan City (TW); Kuang-Xi Hsieh, Taipei City (TW); Chao-Cheng Lee, Jhongli City (TW); Wen-Chi Wang, Siluo Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/774,101

(22) Filed: Feb. 6, 2004

(30) Foreign Application Priority Data
Apr. 17, 2003 (TW) 92108989

(51) Int. Cl. G09G 3/36

(52) U.S. Cl. 345/87

(57) ABSTRACT

An image processing device includes a peripheral circuit and an AFE device. The peripheral circuit is coupled to a display card, and the display signals may be inputted to the AFE device, which processes the display signals, via the peripheral circuit. The image signals outputted from the display card are single-ended analog signals including a red signal, a green signal and a blue signal. The AFE device receives the signals and then utilizes its red, green and blue converters to convert the signals into digital ones. It is to be noted that the red, green, and blue converters share the same ground, which is electrically connected to another ground of the peripheral circuit. Thus, the peripheral circuit and the AFE device have the same reference ground level so as to avoid the distortion caused when the image signals are converted from single-ended ones into the differential ones.

This application claims the benefit of Taiwan application Serial No. 92108989, filed Apr. 17, 2003.

### BACKGROUND OF THE INVENTION

1. Field of the Invention

The invention relates to an image processing device, and more particularly to an image processing device for a digital display.

2. Description of the Related Art

The cathode ray tube (CRT) display technology is always the mainstream of display for a long time, and its associated technology is well developed after several tens of years of improvements. Recently, the display technology has been greatly modified owing to the trend of digitalization. Thus, the digital display tends to replace the CRT monitor.

Unlike the operation method of the conventional analog display, the digital signals of the digital display replace the electron beams of the CRT monitor. So, the digital display may be made thinner and lighter, and makes it possible to get rid of the problems of radiation and frame flickers. The liquid crystal display (LCD) and the plasma display panel (PDP) is representative of the mainstreams of the present digital display technology. At present, because the LCD technology is suitable for the small-scale display and the domestic televisions are mainly the CRT monitors, the application field of the LCD technology in the market is wider than that of the PDP technology.

In the applications of the personal computers, because the display cards (VGA cards) of many computer systems can only output analog image signals, the LCD has to convert the analog signals into digital signals for display. Therefore, the image processing device of the LCD must have an analog front end (AFE) device and a scalar for performing operations of signal conversion and scaling, wherein the AFE device is for converting analog image signals into digital image signals, while the scalar is for computing the digital image signals so as to obtain images with various resolutions. In addition, in order to form the image processing device with complete functions, some other peripheral circuits are needed to be in charge of the signal transmission and hardware connection.

FIG. 1 is a block diagram showing a conventional image processing device. The image processing device includes a peripheral circuit 120 and an AFE device 130 for processing the input image signals from the display card 110. Because the analog image signals are composed of red, green and blue colors of signals, the peripheral circuit 120 and the AFE device 130 need three circuits with the same configuration to process the red, green and blue signals of the image signals, respectively. For the sake of clear illustration, only one of the three sets of the circuits is shown, and the description will be made in the following.

The output image signal from the display card 110 may be equivalent to a current source Iv and is inputted to the peripheral circuit 120 through the cable, and then to the AFE device 130 for analog-to-digital conversion. It is to be noted that the resistors R1 and R2 and capacitor C depicted in the display card 110 and the peripheral circuit 120 are for representing the source and termination resistor and AC coupling capacitor.

On the other hand, the AFE device 130 includes three sets of converter circuits for digitizing the analog image signals, wherein one set of a red converter, a green converter or a blue converter is depicted in the drawing. A clamp device 131 may hold the input image signals from the peripheral circuit 120 at a predetermined level, and the image signals, which may be buffered by an input buffer IB, are inputted to an analog-to-digital converter (ADC) 135 for analog-to-digital conversion. In addition, the variable current source Ioff and the resistor R are serially connected and then coupled to the ground Ground, wherein the gain and offset voltage may be adjusted with the adjustments of the variable current source Ioff and the resistor R.

The signal received by the AFE device 130 is inputted from the distal display card 110 through the cable and the printed circuit board (PCB). In the application, the pattern of the signal is typically single-ended. In order to consider the factors such as noise suppression and the like, a differential signal has to be used in the signal processing of the AFE device 130. Consequently, after the image signals are outputted from the clamp device 131, the input buffer IB may be used to convert the image signals into the differential signals. A problem of signal distortion caused by the different reference ground levels will arise when the single-ended signals are converted into the differential signals. In brief, because the reference ground GND of the display card 110 and the reference ground Ground of the input buffer IB are different (is associated with the frequency—because the bonding inductance exists), the distortion is caused when the single-ended signal is converted into the differential signal, which distortion may be identified by the human eye. The distortion level separably relates to the layout of the peripheral circuit 120 as well as the power inside the AFE device 130. If the layout of the ground plane and the configuration of the power system are better (e.g., a four-layered board is adopted), or the AFE device 130 adopts more pins in relation to the power configuration (e.g., AD9884), it is possible to make the distortion inapparent. However, the designed circuit complexity and the hardware cost will be increased.

Another method for solving this problem is to adopt the differential inputs, as shown in FIG. 2, which is a block diagram showing an image processing device using differential inputs. It is advantageous to adopt the differential inputs because not only the distortion problem may be solved but also the layout of the peripheral circuit 220 is more symmetrical. However, an additional pin has to be added (only one input pin is needed in each converter for the single-ended inputs), and the AFE device 230 may have more complex circuit configuration (e.g., the offset-voltage adjustment circuit of FIG. 1 has to be implemented additionally). In the practical application, the circuits of the AFE device 130 may be integrated in a single chip. If one set of converter additionally has one pin, then three additional pins are included in the red, green, and blue converters. Such a design cannot be easily accepted because the high-cost package for more pins has to be used, or other pins have to be sacrificed after the function or performance is considered.

### SUMMARY OF THE INVENTION

It is therefore an object of the invention to provide an image processing device for a digital display capable of solving the problem of distortion of the differential signal.

The invention achieves the above-identified object by providing an image processing device for a digital display. The device is described in the following.

The image processing device includes a peripheral circuit and an AFE device. The peripheral circuit is coupled to a display card, and the display signals may be inputted to the AFE device, which processes the display signals, via the peripheral circuit. The image signals outputted from the display card are single-ended analog signals including a red signal, a green signal and a blue signal. The AFE device receives the signals and then utilizes its red, green and blue converters to convert the signals into digital ones. It is to be noted that the red, green, and blue converters share the same ground, which is electrically connected to another ground of the peripheral circuit. Thus, the peripheral circuit and the AFE device have the same reference ground level so as to avoid the distortion caused when the image signals are converted from single-ended ones into the differential ones.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a conventional image processing device.

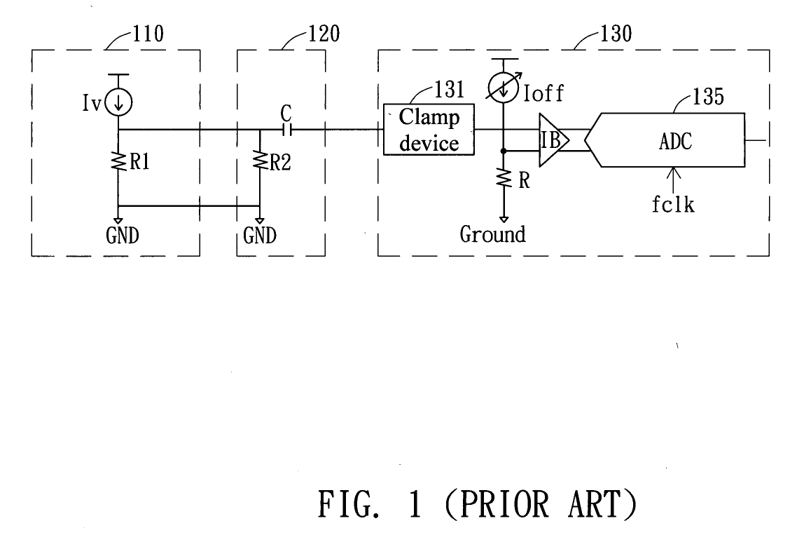

FIG. 2 is a block diagram showing an image processing device using differential inputs.

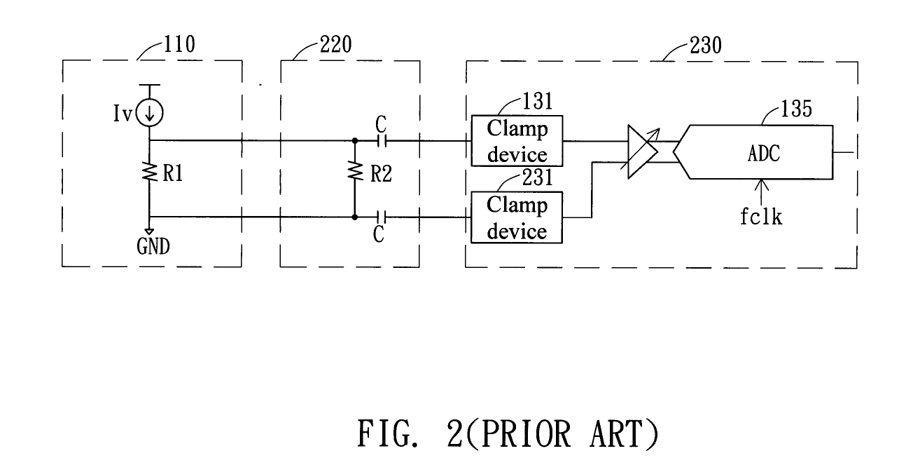

FIG. 3 is a block diagram showing an image processing device according to a first embodiment of the invention.

FIG. 4 is a block diagram showing a LCD controller according to a second embodiment of the invention.

### DETAILED DESCRIPTION OF THE INVENTION

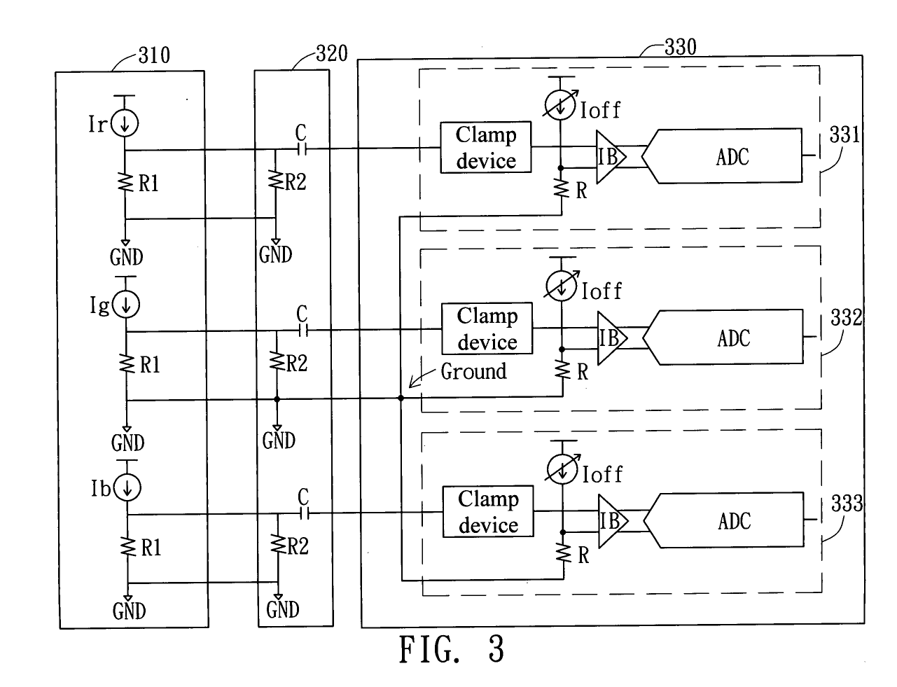

Because the signal distortion will be caused owing to the different reference grounds for the peripheral circuit and the AFE device when the single-end signals are converted into the differential signals, the source of distortion may be eliminated as long as the peripheral circuit and the AFE device have the same reference ground level. FIG. 3 is a block diagram showing an image processing device according to a first embodiment of the invention. Similarly, the display signals of the display card 310 may be inputted to the AFE device 330, which processes the signals, through the peripheral circuit 320. The output image signals from the display card 310 include a red signal, a green signal and a blue signal, which are respectively denoted by current sources Ir, Ig, and Ib. In order to process the red, green and blue signals, three sets of red converter 331, green converter 332 and blue converter 333 with the same configuration have to be disposed in the AFE device 330. Because the three sets of converters have the same operation principle as that of the prior art, detailed descriptions thereof will be omitted. It is to be noted that the red, green and blue converters 331, 332 and 333 in the AFE device 330 share the same ground Ground, and are electrically connected to the ground GND of the peripheral circuit via the ground Ground. Therefore, the peripheral circuit 320 and the AFE device 330 have the same reference ground level, and the source of distortion may be eliminated. Because the red, green and blue converters 331, 332 and 333 share the ground Ground, the AFE device 330 only needs four input pins (R, G, B, and Ground pins), the number of which is only greater than that in the single-ended input configuration, it is unnecessary to significantly modify the original circuit.

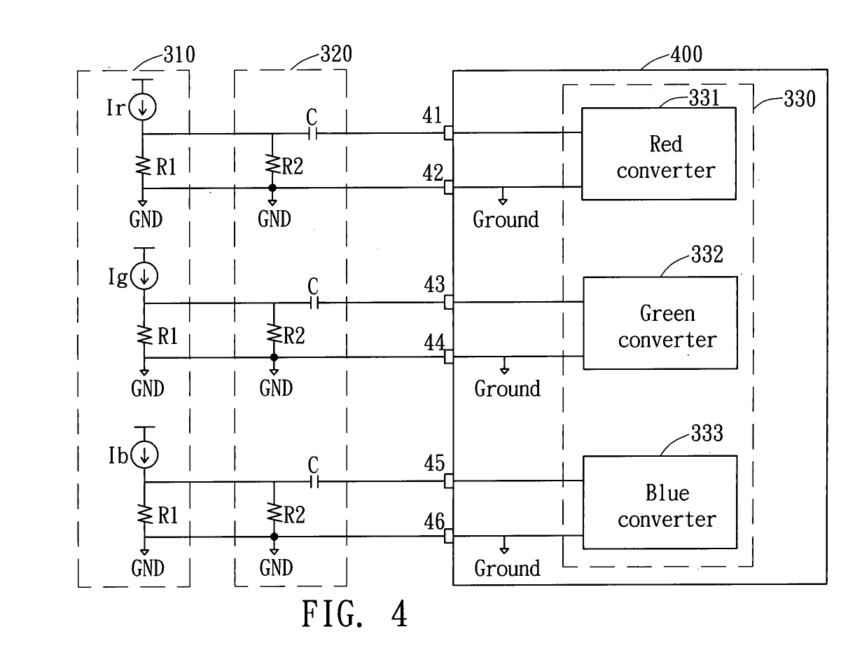

Furthermore, because the different reference ground levels are the factor causing the signal distortion, the distortion problem may be solved as long as the ground levels for each stage of circuits are unified. In order to increase the device integration and to reduce the circuit area, the AFE device and the scalar tend to be integrated in the same LCD controller, which is for processing the input analog image signals from the peripheral circuit, according to the current design trend. FIG. 4 is a block diagram showing a LCD controller 400 according to a second embodiment of the invention. As shown in FIG. 4, the AFE device 330 is disposed in the chip, and is coupled to the peripheral circuit 320 via the pins 41 to 46. The grounds Ground of the LCD controller 400 may be respectively coupled to the grounds GND of the peripheral circuit 320 via the pins 42, 44 and 46, while the pins 41, 43 and 45 respectively receive the red, green signal and blue signals. Most important of all, because the grounds Ground of the LCD controller 400 are coupled to the grounds GND of the peripheral circuit 320, the reference ground potentials for all of the circuits (including the AFE device 330, the scalar, and the like) in the LCD controller 400 are completely the same as those of the grounds GND. Consequently, the problem of signal distortion caused by different ground potentials may be eliminated.

In summary, the image processing device for the digital display of the invention at least has the following advantages.

1. The image signal distortion may be effectively avoided because the peripheral circuit and the AFE device have the same reference ground level.

2. The offset-voltage adjustment circuit in the AFE device in the single-ended input configuration may be remained, and it is unnecessary to design a new offset-voltage adjustment circuit.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing device for a digital display, the device processing image signals inputted from a display card (VGA card) and comprising:
a peripheral circuit, which is coupled to the display card, for transmitting the image signals, wherein the peripheral circuit has a first ground; and
an analog front end (AFE) device, which is coupled to the peripheral circuit, for converting the image signals, wherein the AFE device has a plurality of converters for converting the image signals, and each of the converters shares a second ground that is electrically connected to the first ground.

2. The image processing device according to claim 1, wherein the image signals comprise a red signal, a green signal and a blue signal, and the converters comprise a red converter, a green converter and a blue converter for respectively converting the red, green and blue signals from analog ones into digital ones.

3. The image processing device according to claim 2, wherein the digital display is a liquid crystal display (LCD).

4. An image processing device for a liquid crystal display, the image processing device being disposed in a LCD controller, the LCD controller having a plurality of pins, through which the LCD controller is coupled to a peripheral circuit, the image processing device comprising:
an analog front end (AFE) device for receiving and image-processing analog image signals outputted from the peripheral circuit, the peripheral circuit having a first ground and the AFE device having a second ground, wherein the second ground is electrically connected to the first ground via one of the pins.

5. The image processing device according to claim 4, wherein the image signals comprise a red signal, a green signal and a blue signal, the AFE device comprise a red converter, a green converter and a blue converter for respectively converting the red, green and blue signals from analog ones into digital ones, and each of the red, green and blue converters has a second ground electrically connected to the first ground.

6. The image processing device according to claim 5, wherein each of the second ground is electrically connected to the first ground via one of the pins.

7. The image processing device according to claim 5, wherein the second grounds are electrically connected to the first ground via the same one of the pins.

8. The image processing device according to claim 4, wherein the peripheral circuit is disposed on a printed circuit board.
